(19) United States
(12) Patent Application Publication
(10) Pub. No.: US 2012/0147595 A1
(43) Pub. Date: Jun. 14, 2012

(54) Flashlight Charging Composition Capable of Magnetic Positioning

(76) Inventor: Ching-Hsiang Wang, Tainan City (TW)

(21) Appl. No.: 12/962,719

(22) Filed: Dec. 8, 2010

(51) Int. Cl. F21L 4/00

(52) U.S. Cl. 362/183

(57) ABSTRACT

A flashlight charging composition capable of magnetic positioning includes a flashlight and a charging unit. Positive and negative jacks are disposed at the bottom of the flashlight. The charging unit has a base, a circumferentially-disposed section extending upward from the base to receive the bottom of the flashlight, two protruding members formed inside the circumferentially-disposed section and spaced apart from each other, two clamping sections formed on two opposing sides of the circumferentially-disposed section respectively, and two protruding portions extending from the clamping sections at a preset height thereof respectively. Effectuating a reliable charging equipment entails: inserting the bottom of the flashlight into the circumferentially-disposed section of the charging unit, spreading the clamping sections, engaging the positive and negative jacks and the protruding members respectively, and enabling the protruding portions to abut against corresponding portions of the flashlight precisely.

### FIELD OF THE INVENTION

The present invention provides a flashlight charging composition capable of magnetic positioning. The flashlight charging composition functions as a convenient flashlight charging equipment comprising a flashlight serving a lighting purpose and a freestanding or portable flashlight charging unit for charging a flashlight. The flashlight charging composition enhances reliable positional contact required for charging the flashlight.

### BACKGROUND OF THE INVENTION

Typical power sources for a conventional flashlight serving a lighting purpose are, namely a dry battery disposed therein, and a charging device. Charging devices for use with the conventional flashlight come in various forms. Basically, one end of the conventional flashlight is inserted into the active end of a charging device, such that the charging end of the charging device is in contact with the power inlet end of the flashlight. The charging of the flashlight begins as soon as the plug of the charging device is connected to an electric outlet.

### BRIEF SUMMARY OF THE INVENTION

The present invention provides a novel flashlight charging equipment based on a conventional flashlight serving a lighting purpose and a charging device for use therewith. The flashlight charging equipment operates conveniently, using a freestanding or portable flashlight charging unit. The flashlight charging equipment enhances reliable positional contact required for charging the flashlight.

It is a first primary objective of the present invention to provide a flashlight charging composition for charging a flashlight. The flashlight charging composition comprises a flashlight and a charging unit. Positive and negative jacks are disposed at the bottom of the flashlight. The charging unit further comprises: a base; a circumferentially-disposed section extending upward from the base to receive the bottom of the flashlight; two protruding members formed inside the circumferentially-disposed section and spaced apart from each other; two clamping sections formed on two opposing sides of the circumferentially-disposed section, respectively; and two protruding portions extending from two said clamping sections at a preset height thereof, respectively. Effectuating a reliable charging equipment entails: inserting the bottom of the flashlight into the circumferentially-disposed section of the charging unit, spreading two said clamping sections, engaging the positive and negative jacks at the bottom of the flashlight and two said protruding members of the charging unit respectively, and enabling two said protruding portions of two said clamping sections of the circumferentially-disposed section to abut against corresponding portions of the flashlight precisely.

It is a second primary objective of the present invention to provide a portable flashlight charging composition for charging a flashlight. The portable flashlight charging composition comprises a flashlight and a charging unit. The flashlight further comprises positive and negative jacks disposed at a bottom of the flashlight and a magnetic element disposed between the positive and negative jacks. The charging unit further comprises: a power line, a charging end connected to one end of the power line, two coupling leg members formed on an active side the charging end, and a magnetic element coupled to an inside of the charging end and equidistantly spaced apart from two said coupling leg members. Effectuating a reliable charging equipment entails: engaging the positive and negative jacks at the bottom of the flashlight and two said coupling leg members of the charging unit respectively, and positioning the magnetic element of the charging unit at the magnetic element of the flashlight precisely.

### BRIEF DESCRIPTION OF THE SEVERAL VIEWS OF THE DRAWINGS

FIG. 1 is a schematic exploded view of a flashlight and a charging unit according to the present invention;

FIG. 2 is a schematic side view of the flashlight and the charging unit before engagement thereof according to the present invention;

FIG. 3 is a schematic front view of the flashlight and the charging unit before engagement thereof according to the present invention;

FIG. 4 is a schematic front cross-sectional view of the flashlight after engagement thereof the charging unit according to the present invention; and

FIG. 5 is a schematic exploded view of the flashlight and a portable flashlight charging unit according to the present invention.

### DETAILED DESCRIPTION OF THE EMBODIMENT OF THE INVENTION

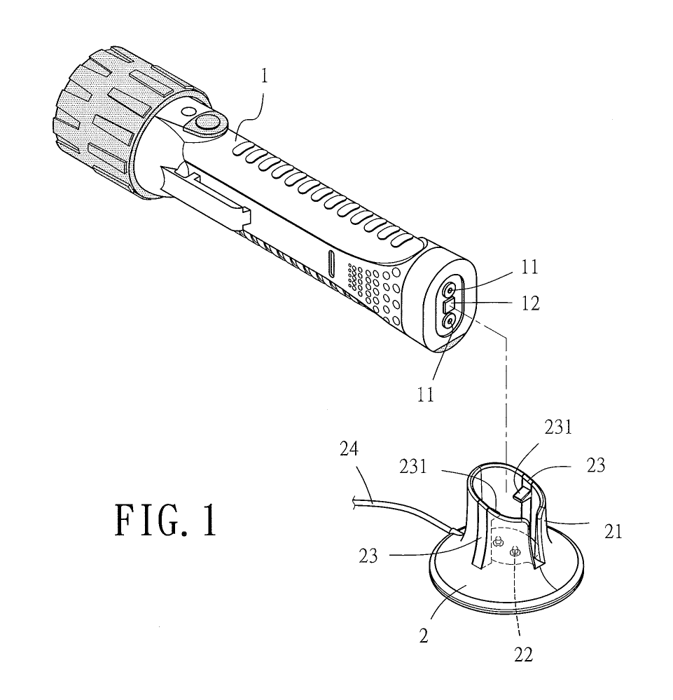

The present invention provides a flashlight charging composition which is capable of magnetic positioning (see FIG. 1) and is configured to charge a flashlight 1. The flashlight charging composition comprises the flashlight 1 and a charging unit 2.

The flashlight 1 has a bottom. Positive and negative jacks 11 are disposed at the bottom of the flashlight 1. A magnetic element 12 is disposed between the positive and negative jacks 11. In this embodiment of the present invention, the magnetic element 12 functions as an attraction positioning equipment in another aspect of application.

The charging unit 2 further comprises: a base of a relatively large width; a circumferentially-disposed section 21 extending upward from the base to receive the bottom of the flashlight 1; two protruding members 22 formed inside the circumferentially-disposed section 21 and spaced apart from each other; two clamping sections 23 formed on two opposing sides of the circumferentially-disposed section 21, respectively; two protruding portions 231 extending from two said clamping sections 23 at a preset height thereof, respectively; and a power line 24 extending from one end of the charging unit 2. In this embodiment of the present invention, the other end of the power line has a plug for insertion into a power socket.

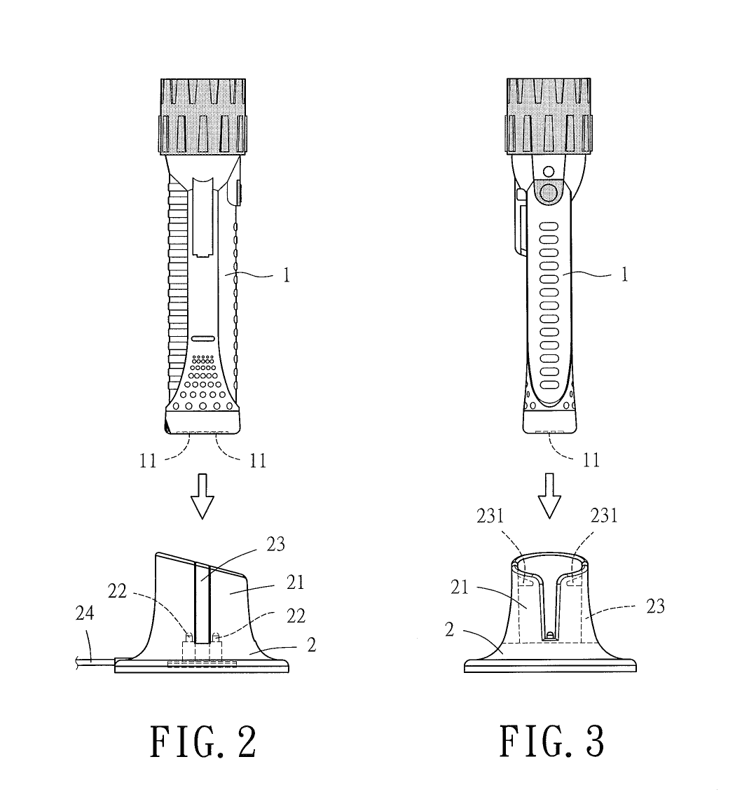

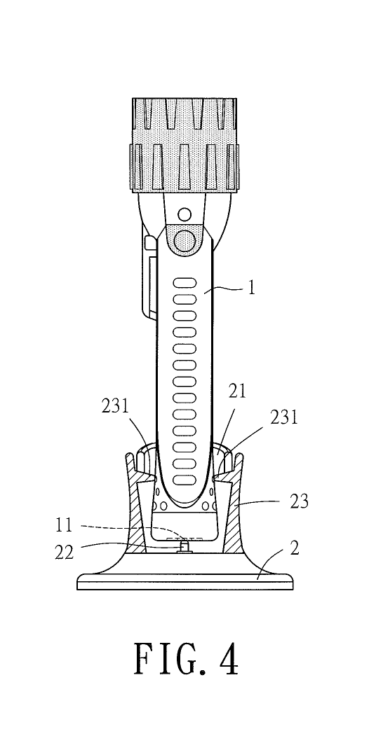

To start charging the flashlight 1 with the charging unit 2 (as shown in FIGS. 2 and 3), it is necessary to insert the bottom of the flashlight 1 into the circumferentially-disposed section 21 of the charging unit 2, spread two said clamping sections 23 (as shown in FIG. 4), engage the positive and negative jacks 11 at the bottom of the flashlight 1 and two said protruding members 22 of the charging unit 2, respectively, and enable two said protruding portions 231 of two said clamping sections 23 of the circumferentially-disposed section 21 to abut against corresponding portions of the flashlight 1 precisely, so as to effectuate a reliable charging equipment.

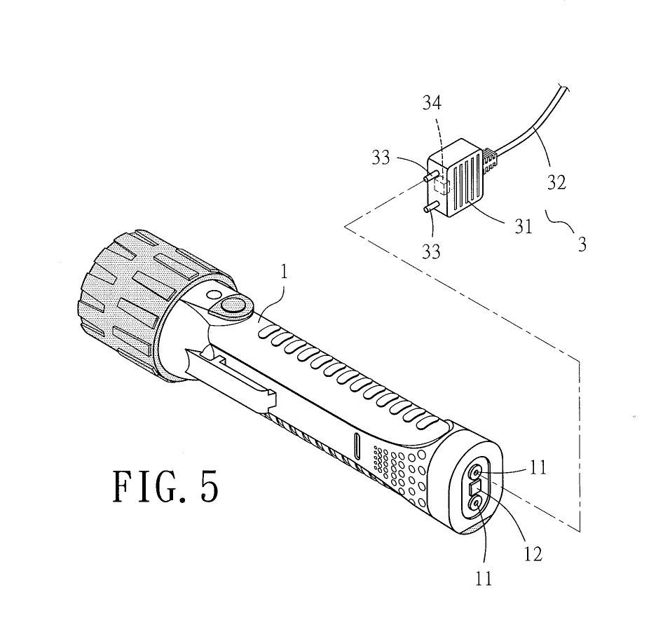

A portable flashlight charging composition for charging the flashlight 1 according to the present invention comprises the flashlight 1 and a charging unit 3 (as shown in FIG. 5).

The flashlight 1 has a bottom. The positive and negative jacks 11 are disposed at the bottom of the flashlight 1. The magnetic element 12 is disposed between the positive and negative jacks 11.

The charging unit 3 further comprises: a power line 32; a charging end 31 connected to one end of the power line 32; a plug (not shown) connected to the other end of the power line 32 and configured for insertion into a power socket (not shown); two coupling leg members 33 formed on the active side the charging end 31; and a magnetic element 34 coupled to the inside of the charging end 31 and equidistantly spaced apart from two said coupling leg members 33.

To start charging the flashlight 1 with the charging unit 3, it is necessary that the positive and negative jacks 11 at the bottom of the flashlight 1 are engaged with two said coupling leg members 33 of the charging unit 3, respectively, and that the magnetic element 34 of the charging unit 3 is precisely positioned at the magnetic element 12 of the flashlight 1, so as to effectuate a reliable charging equipment.

What is claimed is:

1. A flashlight charging composition capable of magnetic positioning and configured to charge a flashlight, the flashlight charging composition comprising:
the flashlight further comprising positive and negative jacks disposed at a bottom of the flashlight; and
a charging unit further comprising: a base; a circumferentially-disposed section extending upward from the base to receive the bottom of the flashlight; two protruding members formed inside the circumferentially-disposed section and spaced apart from each other; two clamping sections formed on two opposing sides of the circumferentially-disposed section, respectively; and two protruding portions extending from two said clamping sections at a preset height thereof, respectively;
wherein operation of charging the flashlight with the charging unit comprises the steps of: inserting the bottom of the flashlight into the circumferentially-disposed section of the charging unit, spreading two said clamping sections, engaging the positive and negative jacks at the bottom of the flashlight and two said protruding members of the charging unit respectively, and enabling two said protruding portions of two said clamping sections of the circumferentially-disposed section to abut against corresponding portions of the flashlight precisely, so as to effectuate a reliable charging equipment.

2. A portable flashlight charging composition capable of magnetic positioning and configured to charge a flashlight, the portable flashlight charging composition comprising:
the flashlight further comprising positive and negative jacks disposed at a bottom of the flashlight and a magnetic element disposed between the positive and negative jacks; and
a charging unit further comprising: a power line, a charging end connected to one end of the power line, two coupling leg members formed on an active side the charging end, and a magnetic element coupled to an inside of the charging end and equidistantly spaced apart from two said coupling leg members;
wherein operation of charging the flashlight with the charging unit comprises the steps of: engaging the positive and negative jacks at the bottom of the flashlight and two said coupling leg members of the charging unit respectively, and positioning the magnetic element of the charging unit at the magnetic element of the flashlight precisely, so as to effectuate a reliable charging equipment.
